(19) United States
(12) Patent Application Publication
(10) Pub. No.: US 2006/0242697 A1
(43) Pub. Date: Oct. 26, 2006

(54) SOFTWARE AUTHENTICATION DEVICE AND IMAGE FORMING DEVICE

(75) Inventor: Masataka TAKEMURA, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/379,577

(22) Filed: Apr. 21, 2006

(30) Foreign Application Priority Data
Apr. 26, 2005 (JP) 2005/127657

(51) Int. Cl. G06F 12/14

(52) U.S. Cl. 726/19

(57) ABSTRACT

A software authentication device for an image forming device is disclosed that includes a key code read-out unit that reads out a predetermined key code from a hardware key storing the key code, a determination unit that determines whether the key code read out is authentic or not, and a first authentication unit that activates a software application installed in the device if it is determined that the key code is authentic. The software authentication device includes a hardware-key invalidating unit that erases or alters the key code stored in the hardware key if the determination unit determines that the key code is authentic.

### CROSS-REFERENCE TO RELATED APPLICATIONS

This application claims priority to Japanese Patent Application No. 2005-127657. The entire disclosure of Japanese Patent Application No. 2005-127657 is hereby incorporated herein by reference.

### BACKGROUND OF THE INVENTION

1. Field of the Invention

The present invention relates to a software authentication device having a key code read-out unit that reads out key codes from a hardware key that stores hardware keys, a determination unit that determines whether a key code read out is authentic or not, and an authentication unit that activates a software application installed in a device if it is determined that the key code is authentic.

2. Background Information

A key authentication device for use with a computer has been proposed to ensure the security of an information processing device, and comprises a connector as a means of allowing a key device having key information programmed therein to be attached thereto and removed therefrom, a comparing unit for comparing the key information of the key device with the pre-registered key information when the power is turned on, and an activating unit for activating an operating system when the result of the comparison indicates an agreement in the two key information.

In addition, a software authentication device has been proposed for activating a software application installed in computers in order to eliminate unauthorized use of software. Examples of the software authentication devices include a device with an authentication unit that activates a software application according to a specific license code entered through data input unit such as a keyboard. Another example is a device having an authentication server that activates a software application according to a specific license code sent from a terminal through the Internet.

In the authentication device in which the specific license code is input through the data input unit to perform authentication, the license code described on a document and contained in a software package is input into the device in which the software application is installed. However, there is a disadvantage in this type of device, because any person who knows the license code will be able to install the software in another device and illegally use the software.

On the other hand, when the authentication is executed by using an authentication server that is connected through the Internet, the license code of the software application and the serial number of the device in which the software application is installed are both verified in the authentication; therefore, it is possible to effectively eliminate the illegal installation of a software application in another device. However, this device must be connected to the Internet. This results an increase in the cost for setting up the equipment for the user.

One possible approach to solve the problem of an increase in the cost is to use an authentication device constructed such that a hardware key storing a specific license code is set in a media reader provided in the device, and a software application is activated based on the license code that is read out therefrom, wherein the hardware key additionally stores the serial number of the device in which the software application is installed (see for example Japan Published Patent Application No. 2002-251226).

Recently, another information processing device with a software authentication device has been proposed. This software authentication device activates software so as to be usable to only users who have purchased a license, and various software applications can be pre-installed in the information processing device. However, in order to eliminate unauthorized use of the software, the user must activate the software application to use the software. An application using a hardware key having a license code stored therein may be used, which will result an increase in the cost of the parts used, and an increase in administration costs, because the serial number of the device and the license code must both be administered.

In particular, the above described process in which a software application is pre-installed in an image forming device requires a tremendous amount of work. In order to prevent unauthorized use of the software application, the following actions are required. First, after a user has purchased a license to legally use a software application, a service engineer will have to visit the location where the image forming device is installed, operate the device in order to enter the license code of the user, and set a hardware key into a media reader in the device in order to activate the software application.

Accordingly, an object of the present invention is to provide.

In view of the above, it will be apparent to those skilled in the art from this disclosure that there exists a need for an improved image forming device and a software authentication device that are capable of eliminating the unauthorized use of software without having to manage, for example, license codes and device serial numbers. This invention addresses this need in the art as well as other needs, which will become apparent to those skilled in the art from this disclosure.

### SUMMARY OF THE INVENTION

A software authentication device according to a first aspect of the invention comprises a key code read-out unit configured to read out a predetermined key code from a hardware key storing the key code; a determination unit configured to determine whether the key code read out is authentic or not; an authentication unit configured to activate a software application installed in a device if the key code is determined to be authentic; and a hardware-key invalidating unit configured to erase or alter the key code stored in the hardware key if the key code is determined to be authentic.

With this arrangement, if the determination unit determines that the key code read out by the key code read-out unit is authentic, the software application installed is activated, and the hardware-key invalidating unit erases or alters the key code stored in the hardware key. As a result, no one else can reuse the hardware key for illegal purposes. In other words, once the hardware key is used, the key code is erased thereby preventing reuse of the key code. Even if the management of, for example, the serial number of the device in which the software application is installed is not performed, the key code will not be illegally used in another device. In addition, administration costs are considerably reduced. It is only necessary for a serviceman to deliver the hardware key to the purchaser of the license. The serviceman does not have to go to the location where the image forming device is installed.

According to a second aspect of the invention, the key code read-out unit comprises a second authentication unit that reads out a key code stored in a security area of the hardware key.

With the provision of the second authentication unit, when the hardware key storing the key code in an area protected by security is used, the key code cannot be read out if the key code is not authenticated by the second authentication unit. Accordingly, even if an unused hardware key is transferred to a third party that intends to illegally use the key, there is hardly any chance that the key will be illegally used. The second authentication unit may comprise, for example, a password input unit that allows access to an area protected by security, and a verification unit that verifies a password input.

According to a third aspect of the invention, the key code is set to be a common value irrespective of the serial number of the software application or the serial number of the device in which the software application is pre-installed.

The above-mentioned configuration saves time and labor because it will not be necessary to manage key codes individually in connection with the corresponding serial numbers of software applications, which will remarkably reduce administration costs.

As seen from the foregoing description, a major feature of an image forming device according to the present invention is that the software application is pre-installed in the image forming device, and the first software authentication device is incorporated into the device. An image forming device in accordance with the present invention can reduce various administration costs, effectively eliminate illegal use of software, and activate only a software application which is pre-installed into an image forming device of a license purchaser.

As described above, the present invention successfully provides an image forming device and a software authentication device which is capable of eliminating unauthorized use of software without troublesome management of, for example, license codes and device serial numbers.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a block diagram showing the functions of a software authentication device;

FIG. 2 shows the external appearance of a digital copying machine;

FIG. 3 shows an operation unit of the copying machine;

FIG. 4 is a circuit diagram showing the circuit arrangement of the operation unit;

FIG. 5 describes the security area of a hard key; and

FIG. 6 is a flow chart for describing the software authentication operation.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

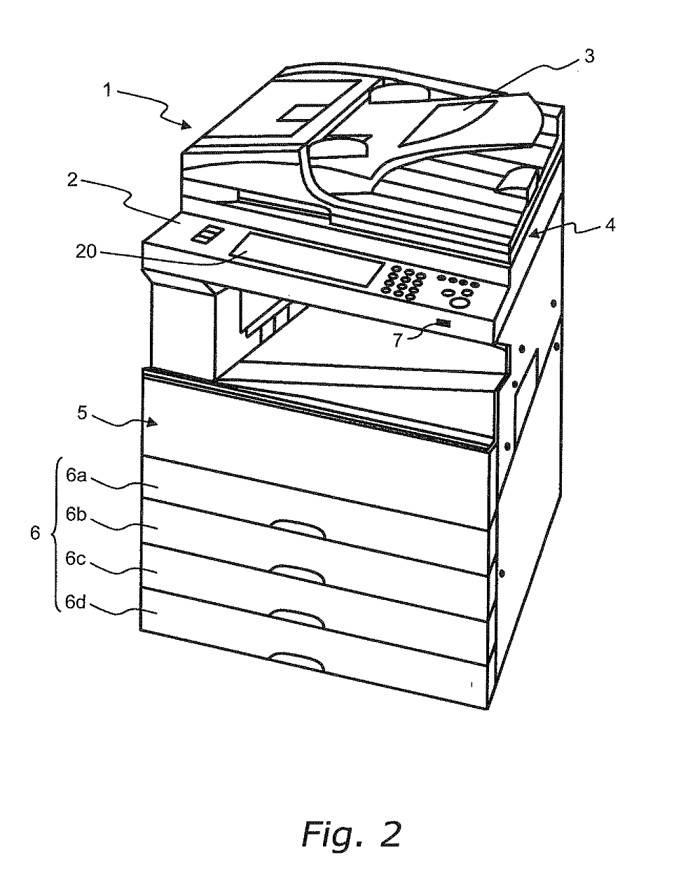

An image forming device with an authentication device incorporated therein in accordance with the present invention will be describe below. A digital copying machine 1 as an image forming device is, as shown in FIG. 2, comprised of an operation panel 2, an image reader 4, an electrophotography-based image forming section 5, a plurality of sheet feeding cassettes 6 (6a to 6d ) containing various sizes and types of recording sheets therein, and a manual sheet feeding port, not shown in the drawings, which is provided on the left side of the machine. The operation panel 2 has an arrangement that includes a copy mode setting key for setting various copy modes, and a print key for starting a copying operation after the desired copy mode is set. The image reader 4 sequentially reads a series of original documents set on a sheet holding platen 3, and converts the read document into electronic data. The image forming section 5, located under the image reader 4, forms a toner image on a recording sheet based on the image data converted from the electronic data produced by the image reader 4.

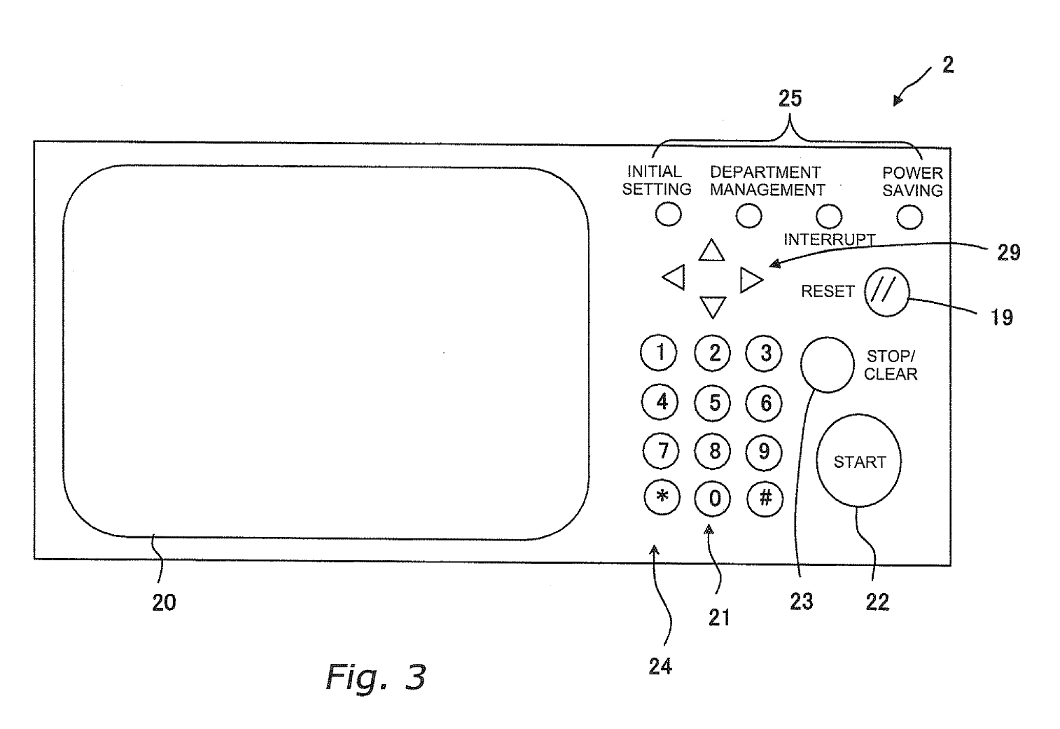

The operation panel 2 is located on the front side of the image reader 4, and comprises, as shown in FIG. 3, a touch panel type color LCD display unit 20 as a display section located on the left side, and an operation key group 24 including various operation keys located on the right side. The operation key group 24 comprises a basic control key group in order to control copying operations, and special mode setting keys 25. The control key group includes, for example, numerical keys 21 for setting the number of copies, a start key 22, a clear/stop key 23, cursor keys 29, and a reset key 19.

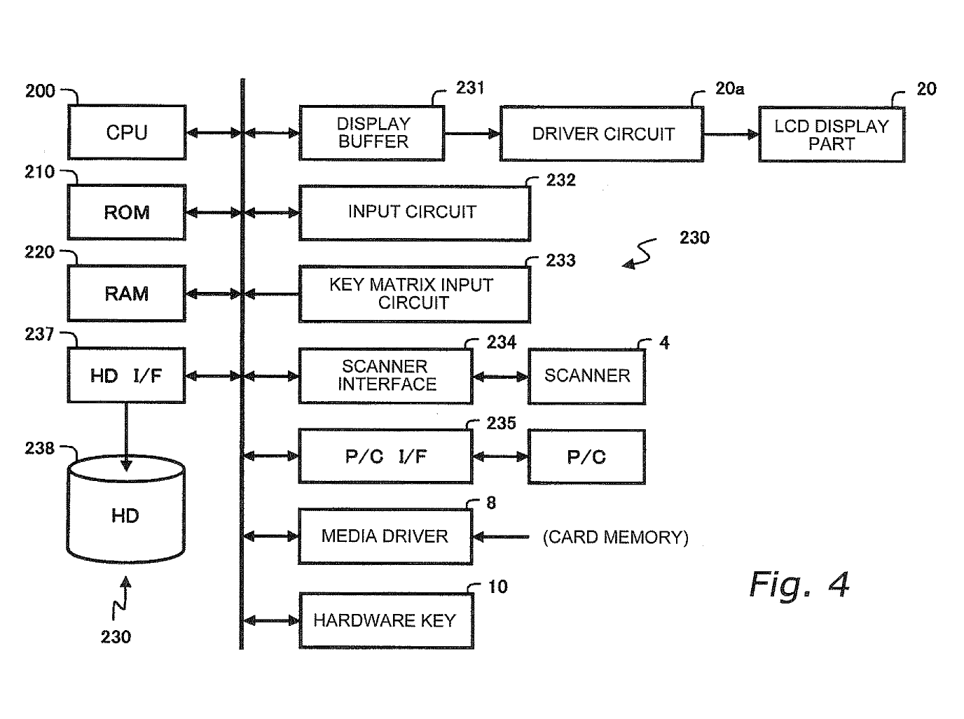

A media driver 8 of the operation panel 2 is arranged such that a CPU 200, a ROM 210, a RAM 220, and different input-output circuits 230 are connected to each other by an internal bus, as shown in FIG. 4. The CPU 200 controls the input and the output of data to and from the keys and the color LCD display unit 20 provided on the operation panel 2, and transfers data of the set copy mode, for example, to the control CPUs of the image reader 4 and the image forming section 5. The ROM 210 stores programs to be executed by the CPU 200. The nonvolatile RAM 220 is used as a working area. The input-output circuits 230 include a display buffer 231 for supplying display data to a driver circuit 20a in the color LCD display unit 20, an input circuit 232 to transparent electrode sheet switches formed on a surface of the color LCD display unit 20, a key matrix input circuit 233 which receives various key inputs, a scanner interface 234 connected to the image reader 4, an interface circuit 235 connected to an external personal computer, a media driver 8, an interface circuit 237 connected to a hard disc unit 238, and the like. The input-output circuit may be connected to a hardware key 10 described later through a USB (universal serial bus) terminal 7.

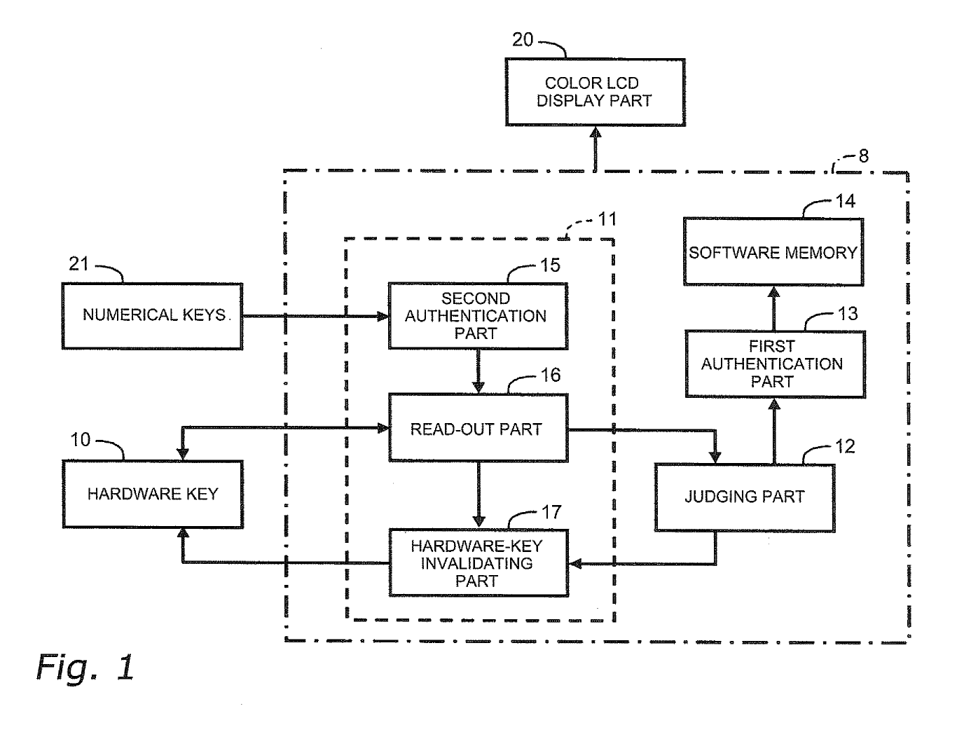

A functional block configuration for authenticating a software application pre-installed into the digital copying machine 1 includes, as shown in FIG. 1, a software memory 14 storing the software application pre-installed into the digital copying machine 1, a key code read-out unit 11 for reading a first key code from the hardware key 10 having the first key code stored therein through the USB terminal 7, a determination unit 12 that determines whether the first key code read by the key code read-out unit 11 is authentic or not, and a first authentication unit 13 that activates the software application stored in the software memory 14 when the determination unit 12 determines that the first key code is authentic. The software application stored in the software memory 14 is, for example, a utility software application such as a compressed PDF editing software application. The utility software application is protected such that a user of the digital copying machine 1 cannot use the utility software unless the first authentication unit 13 activates the software application after an option contract has been agreed to by the user. In addition, the software memory 14 is formed in a predetermined memory area of the hard disc unit 238.

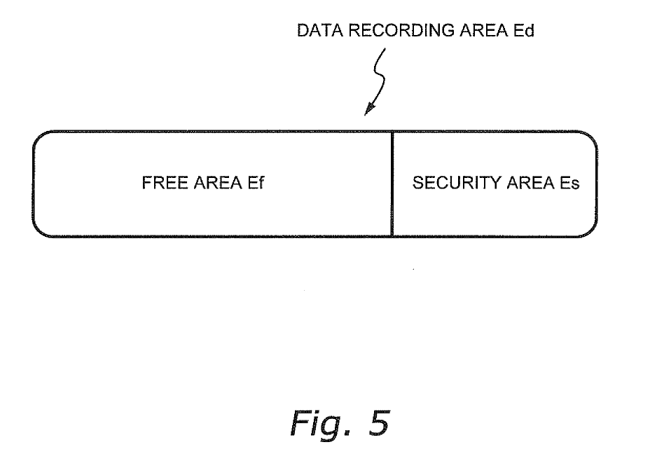

A medium such as a flash memory may be employed as the hardware key 10, as shown in FIG. 5, for example. A freely accessible free area Ef and a security area Es that is protected by a predetermined second key code are separately provided in a data recording area Ed in the flash memory. Data can be read out from the security area Es by inputting the second key code, and can be erased or altered by the same operation. In other words, the hardware key 10 is configured such that the first key code is stored in the security area Es protected by the second key code. Furthermore, the hardware key 10 may be connected to the digital copying machine 1 through the USB terminal 7. Moreover, the data recording area Ed does not necessarily have to be separated into the free area Ef and the security area Es. For example, the entire data recording area Ed may be comprised of the security area Es.

Referring back to FIG. 1, the key code read-out unit 11 functions to read the first key code from the hardware key 10 through the USB terminal 7. The key code read-out unit 11 comprises a second authentication unit 15 that reads out the first key code stored in the security area of the hardware key 10, a read-out unit 16 that reads out the first key code from the hardware key 10 if the second authentication unit 15 authenticates the first key code, and a hardware-key invalidating unit 17 that erases or alters the first key code in the hardware key 10 under one or more predetermined conditions.

When a user enters a predetermined third key code pre-assigned to the user through the key group, the second authentication unit 15 compares the third key code previously stored in the second authentication unit with the third key code input. If the key codes match, the second authentication unit 15 permits the read-out unit 16 to read out the first key code from the hardware key 10.

If the read-out unit 16 is permitted by the second authentication unit 15 to read the first key code from the hardware key 10, the read-out unit 16 accesses the security area Es in the hardware key 10 using the second key code stored in the read-out unit 16, and reads out the first key code from the security area Es.

If the determination unit 12 determines that the first key code read out by the read-out unit 16 is authentic, the hardware-key invalidating unit 17 erases or alters the first key code stored in the hardware key 10.

The determination unit 12 determines whether the first key code read out by the read-out unit 16 is authentic or not. The determination unit 12 compares the first key code previously stored therein with the first key code read out. If the key codes match, the determination unit 12 determines that the first key code read out is authentic.

If the determination unit 12 determines that the first key code is authentic, the first authentication unit 13 activates a software application stored in the software memory 14 to enable the utilization of the software application.

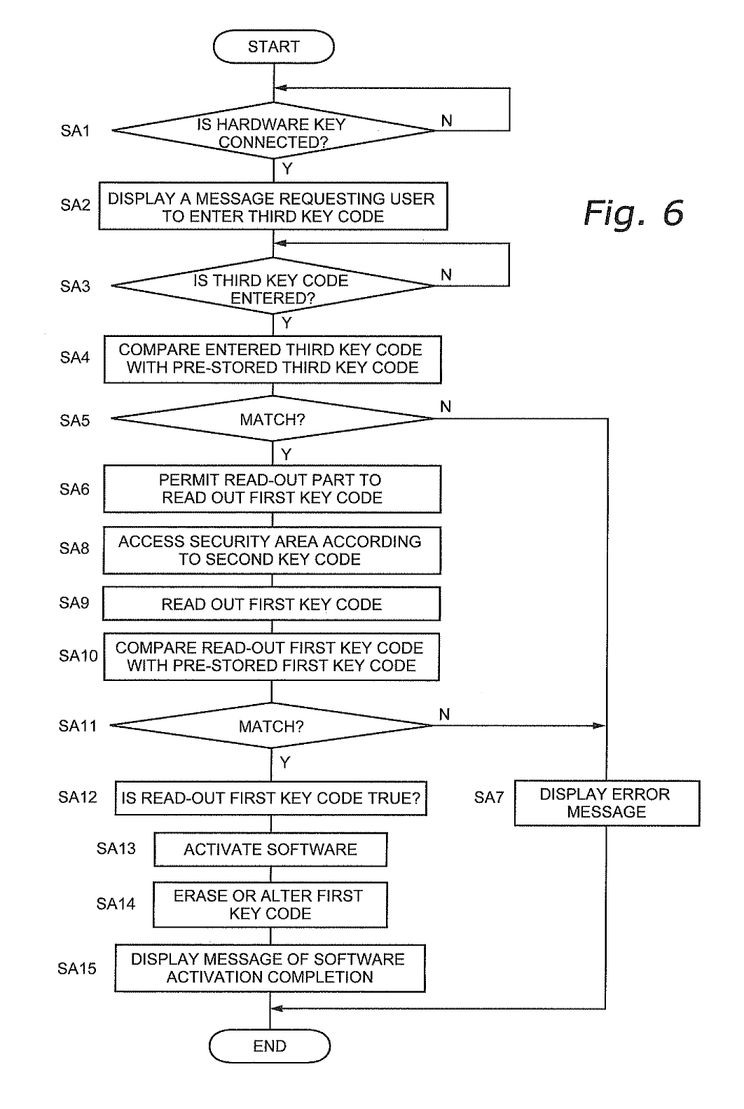

The operation of authenticating a software application previously stored in the digital copying machine 1 will be described using a flow chart shown in FIG. 6. When the hardware key 10 is connected to the USB terminal 7 (SA1), the second authentication unit 15 causes the color LCD display unit 20 to display a message requesting a user to enter a third key code (SA2).

When the user enters the third key code by operating the numerical keys 21 (SA3), the second authentication unit 15 compares the third key code entered by the user with a third key code previously stored (SA4). If the key codes match (SA5), the second authentication unit 15 permits the read-out unit 16 to read out a first key code from the hardware key 10 (SA6). If those key codes do not match (SA5), the second authentication unit 15 signals the color LCD display unit 20 to display an error message (SA7).

When the read-out unit 16 is permitted by the second authentication unit 15 to read the first key code from the hardware key 10, the read-out unit 16 accesses the security area Es in the hardware key 10 using the second key code previously stored (SA8), and reads out the first key code from the security area Es (SA9).

The determination unit 12 compares the first key code read out by the read-out unit 16 with the previously stored first key code (SA10). If those key codes match (SA11), the determination unit 12 determines that the read out first key code is authentic (SA12). If the key codes do not match (SA11), the determination unit 12 signals the color LCD display unit 20 to display an error message (SA7).

If the determination unit 12 determines that the first key code read out is authentic, the first authentication unit 13 activates a software application stored in the software memory 14 to enable the utilization thereof (SA13).

The hardware-key invalidating unit 17 erases or alters the first key code stored in the hardware key 10 (SA14), and causes the color LCD display unit 20 to display a message stating that the software has been activated (SA15).

It is preferable that the first key code is set to be a common value irrespective of the serial numbers respectively assigned to software applications or serial numbers assigned to devices in which the software applications are pre-installed. Thus, administrative costs will be remarkably reduced since there will be no need to individually manage the key codes in connection with the corresponding management numbers.

Another embodiment according to the present invention will be described below. In the embodiment described above, the second authentication unit 15 compares the third key code entered by the user with the previously stored third key code, and if the key codes match, the second authentication unit permits the read-out unit to read out the first key code from the hardware key 10. However, in this embodiment, the second authentication unit 15 stores the second key code first and compares the second key code entered by the user with the previously stored second key code. If the key codes match, the second authentication unit 15 permits the read-out unit to read out the first key code from the hardware key 10.

While a flash memory type of the USB key is employed as the hardware key in the embodiments mentioned above, a data rewritable semiconductor memory card may be employed as the hardware key.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A software authentication device, comprising:
a key code read-out unit configured to read out a predetermined key code from a hardware key that stores the key code;
a determination unit configured to determine whether the key code read out from the hardware key is authentic or not;
a first authentication unit configured to activate a software application installed in a device if the key code is determined to be authentic; and
a hardware-key invalidating unit configured to erase or alter the key code stored in the hardware key if the key code is determined to be authentic.

2. The software authentication device according to claim 1, wherein the key code read-out unit comprises a second authentication unit configured to read out a key code stored in a security area of the hardware key.

3. The software authentication device according to claim 2, wherein the second authentication unit comprises a password input unit that allows access to the security area, and a verification unit that verifies a password that has been input.

4. The software authentication device according to claim 1, wherein the key code is set to be a common value irrespective of an identification number of the software application or an identification number of the device in which the software application is pre-installed.

5. The software authentication device according to claim 2, wherein the key code is set to be a common value irrespective of an identification number of the software application or an identification number of the device in which the software application is pre-installed.

6. A software authentication device, comprising:
a key code read-out unit comprising a second authentication unit that reads out a predetermined key code from a security area of a hardware key;
a determination unit configured to determine whether the key code read out from the hardware key is authentic or not;
an authentication unit configured to activate a software application installed in a device if the key code is determined to be authentic; and
a hardware-key invalidating unit configured to erase or alter the key code stored in the hardware key if the key code is determined to be authentic.

7. An image forming device comprising the software authentication device of claim 1, wherein the software application is pre-installed in the image forming device.
